(19) United States
(12) Patent Application Publication
(10) Pub. No.: US 2007/0249496 A1
(43) Pub. Date: Oct. 25, 2007

(54) Catalyst for Production of Hydrogen

(76) Inventors: Jon P. Wagner, Louisville, KY (US); Yeping Cai, Louisville, KY (US); Aaron L. Wagner, Rochester, NY (US); Michael W. Balakos, Buckner, KY (US)

Correspondence Address: SUD-CHEMIE INC., 1600 WEST HILL STREET, LOUISVILLE, KY, 40210, US

(21) Appl. No.: 11/622,360

(22) Filed: Jan. 11, 2007

Related U.S. Application Data
(63) Continuation-in-part of application No. 10/108,814, filed on Mar. 28, 2002, now abandoned.
(63) Continuation-in-part of application No. 10/758,552, filed on Jan. 15, 2004, now abandoned.

(51) Int. Cl. B01J 23/00; B01J 23/06; B01J 23/16; B01J 23/38; B01J 23/70

(52) U.S. Cl. 502/303; 502/302; 502/304; 502/306; 502/309; 502/312; 502/315; 502/316; 502/317; 502/318; 502/321; 502/324; 502/325; 502/326; 502/337; 502/338; 502/339; 502/344; 502/345; 502/347

(57) ABSTRACT

The present development is a catalyst for use in the water-gas-shift reaction. The catalyst includes a Group VIII or Group IB metal, a transition metal promoter selected from the group consisting of rhenium, niobium, silver, manganese, vanadium, molybdenum, titanium, tungsten and a combination thereof, and a ceria-based support. The support may further include gadolinium, samarium, zirconium, lithium, cesium, lanthanum, praseodymium, manganese, titanium, tungsten or a combination thereof. A process for preparing the catalyst is also presented. In a preferred embodiment, the process involves providing “clean” precursors as starting materials in the catalyst preparation.

### CROSS-REFERENCE TO RELATED APPLICATIONS

The present application is a continuation-in-part application related to U.S. application Ser. No. 10/108,814 filed on Mar. 28, 2002, now abandoned, and to U.S. application Ser. No. 10/758,552 filed on Jan. 15, 2004, pending, and incorporated herein in its entirety by reference.

### BACKGROUND

The present development is a high efficiency catalyst for use in the water-gas-shift reaction suitable for production of hydrogen. The catalyst includes a Group VIII or Group IB metal and a transition metal promoter on a ceria-based support. The transition metal promoter is selected from the group consisting of rhenium, niobium, silver, manganese, vanadium, molybdenum, titanium, tungsten and a combination thereof. The support may further include gadolinium, samarium, zirconium, lithium, cesium, lanthanum, praseodymium, manganese, titanium, tungsten or a combination thereof.

Large volumes of hydrogen gas are needed for a number of important chemical reactions, and since the early 1940's, the water-gas-shift (WGS) reaction has represented an important step in the industrial production of hydrogen. For example, the industrial scale water-gas-shift reaction is used to increase the production of hydrogen for refinery hydro-processes and for use in the production of bulk chemicals such as ammonia, methanol, and alternative hydrocarbon fuels.

The hydrogen gas is produced from the reaction of hydrocarbons with water or oxygen and from the reaction of carbon or carbon monoxide with water. The hydrocarbons are typically reacted with water and/or oxygen in the presence of supported nickel catalysts and at high temperatures to produce a combination of carbon oxides and hydrogen gas, commonly referred to as synthesis gas or syngas (see equations 1-3):
CH₄+H₂O→CO+3H₂ (1)
CₙHₘ+nH₂O→nCO+(n+m/2)H₂ (2)
CH₄+½O [symbol] CO+2H₂ (3)
Alternatively, the syngas can be produced through the gasification of coal (equation 4):
C+H₂O→CO+H₂ (4)
In the subsequent water-gas-shift reaction (equation 5),
CO+H₂O [symbol] CO₂+H₂ΔH°₂₉₈=−41.1 kJ mol⁻¹ (5)
the composition of the so-called water gas can be adjusted to the desired ratio of hydrogen and carbon monoxide. (For a more detailed review of synthesis gas generation and application, see for example E. Supp, Rohstoff Kohle, Verlag Chemie, Weinheim, N.Y., 136 (1978); P. N. Hawker, Hydrocarbon Processing, 183 (1982), incorporated herein by reference).

Typically, the catalysts used in the industrial scale water-gas-shift reaction include either an iron-chromium (Fe—Cr) metal combination or a copper-zinc (Cu—Zn) metal combination. The Fe—Cr oxide catalyst works extremely well in a two stage CO conversion system for ammonia synthesis and in industrial high temperature shift (HTS) converters. In the two stage ammonia synthesis Fe—Cr oxide catalyzed reaction, the catalyst is heated to temperatures ranging from about 320° C. to about 400° C. and the CO level is reduced from about 10% to about 3500±500 ppm. However, in single stage converters the Fe—Cr oxide catalysts are not as effective and the CO level is only reduced to about 1%. The industrial HTS converters—which have reactor inlet temperatures of from about 300° C. to about 380° C.—exclusively use the Fe-based catalysts because of their excellent thermal and physical stability, poison resistance and good selectivity. These attributes are especially beneficial when low steam to CO ratios are used and the formation of hydrocarbons is favored. (See K. Kochloefl, ‘Water Gas Shift and COS Removal’ in “Handbook of Heterogeneous Catalysis”, G. Ertl, H. Knözinger, and J. Weitkamp (Ed.), VCH, Ludwigshafen, 4, Chapter 3.3, pp. 1831-1843 (1997), incorporated herein by reference, for a more extensive discussion of HTS catalysts.) Typically, the commercial catalysts are supplied in the form of pellets containing 8-12% Cr₂O₃ and a small amount of copper as an activity and selectivity enhancer.

The copper-based catalysts function well in systems where the CO₂ partial pressure can affect the catalyst performance. It is known that the CO₂ partial pressure in the reacting gas exerts a retarding effect on the forward rate constant, but over copper based catalysts the effect is negligible. Therefore, copper-based catalysts demonstrate more favorable CO conversion at lower temperatures. However, the unsupported metallic copper catalysts or copper supported on Al₂O₃, SiO₂, MgO, pumice or Cr₂O₃ tend to have relatively short lifespan (six to nine months) and low space velocity operation (400 to 1000 h⁻¹). The addition of ZnO or ZnO—Al₂O₃ can increase the lifetime of the copper-based catalysts, but the resultant Cu—Zn catalysts generally function in a limited temperature range of from about 200° C. to about 300° C. The Cu—Zn commercial catalysts are supplied in the form of tablets, extrusions, or spheres and are usually produced by co-precipitation of metal nitrates.

Although Fe—Cr and Cu—Zn catalysts are efficient when used in a commercial syngas generation facility, they are not readily adaptable for use in stationary fuel cell power units or mobile fuel cells which generate hydrogen from natural gas or liquid fuel. For example, the catalysts used in the fuel cell reformer must have a high level of activity under high space velocity operation conditions because relatively large volumes of hydrocarbons are passed over the catalyst bed in a relatively short period of time. Moreover, the catalyst bed volume must be extremely small as compared to a commercial syngas generation facility. A typical syngas generation facility uses reformer catalyst beds having average volumes ranging from about 2 m³ to about 240 m³, whereas stationary fuel cell reformer catalyst bed volumes are around 0.1 m³ and mobile fuel cell catalyst beds have volumes of about 0.01 m³. Further, the mobile fuel cell catalyst must be capable of retaining activity after exposure to condensing and oxidizing conditions during a large number of startup and shutdown cycles, and the catalyst must not require a special activation procedure or generate substantial heat when switching from reducing to oxidizing conditions at elevated temperatures. The mobile fuel cell catalyst must also tolerate an oxygen rich atmosphere in contrast to the Cu—Zn catalysts which are pyrophoric and which require steam removal and a nitrogen blanket upon reactor shut-down to minimize condensation formation and related deactivation. Because the hydrocarbon source for fuel cells may include contaminating materials such as sulfur, the catalyst should also have a relatively high poison resistance.

As noted above, catalysts designed for use in fuel cell reformer beds must have a high level of activity under high space velocity operation conditions. Thus, high efficiency transition metals have been considered for use in the limited bed-volume fuel cells. Academic studies have demonstrated that for transition metals in the metallic state, the relative activity order in the water-gas-shift reaction is Cu>Re>Ru>Ni>Pt>Os>Au>Fe>Pd>Rh>Ir (see for example “Steam Effects in Three-Way Catalysis,” authored by J. Barbier Jr., and D. Duprez, Applied Catalysis B: Environmental, 4, 105 (1994) and the references cited therein, incorporated herein by reference). Hence, if the water-gas shift reaction was to occur in isolation and under ideal conditions, the transition metal could be selected based solely on the relative activity. However, in actual field applications, the water-gas shift reaction is affected by its environment, and catalysts—consisting of selected metals and related supports—must be designed taking the fuel cell reaction conditions and the catalyst support into account.

Cerium oxide is generally recognized as an efficient support for water-gas-shift catalysts. This support material has been shown to affect the performance of the transitions metals carried: platinum, rhodium and palladium are not generally regarded to be good water gas shift catalysts because they are not easily oxidized by water, but when these metals are ceria-supported, they are active shift catalysts. (For a more extensive discussion of water-gas-shift catalysts, see for example “Studies of the Water-Gas-Shift Reaction on Ceria-Supported Pt, Pd, and Rh: Implications for Oxygen-Storage Properties,” T. Bunluesin, R. J. Gorte, and G. W. Graham, Applied Catalysis B: Environmental, 15, 107 (1998) and the references cited therein, and “A Comparative Study of Water-Gas-Shift Reaction Over Ceria Supported Metallic Catalysts” S. Hilaire, X. Wang, T. Luo, R. J. Gorte, and J. P. Wagner, Applied Catalysis A: General, 215, 271 (2001) and the references cited therein, incorporated herein by reference.) Further, the cerium oxide has a surface area of from about 10 m²/g to about 200 m²/g and a crystallite size range which appears to facilitate the water-gas-shift reaction.

Over the past few years, various transition metal/support combinations have been proposed as efficient fuel cell catalysts. In U.S. Pat. No. 6,777,177, Igarashi et al. propose using platinum alone or in combination with rhenium and/or yttrium, calcium, chromium, samarium, cerium, tungsten, neodymium, praseodymium, magnesium, molybdenum and/or lanthanum as a fuel cell catalyst. Despite the recognized benefits of cerium oxide supports for water gas shift catalysts, in the '177 patent, Igarashi et al. rely solely on zirconia, alumina, silica, silica-magnesia, zeolite, magnesia, niobium oxide, zinc oxide, chromium oxide, the afore-mentioned metal oxides coated with titania, and titania supports for use in fuel cell catalysts. Alternatively, in U.S. Pat. No. 6,455,182, Silver selects a cerium oxide/zirconium oxide support for the fuel cell catalyst, but limits the selection of transition metals to be supported to rhenium, platinum, palladium, rhodium, ruthenium, osmium, iridium, silver or gold, wherein only the platinum, palladium, rhodium and gold may be used in combination.

### SUMMARY OF THE PRESENT DEVELOPMENT

The present development is a catalyst for use in the water-gas-shift reaction. The catalyst comprises a primary transition metal selected from the group consisting of iron, cobalt, nickel, copper, ruthenium, rhodium, palladium, silver, osmium, iridium, platinum, gold, cadmium and a combination thereof; a transition metal promoter selected from the group consisting of rhenium, niobium, silver, manganese, vanadium, molybdenum, titanium, tungsten and a combination thereof; and a ceria-based support further comprising gadolinium, samarium, zirconium, lithium, cesium, lanthanum, praseodymium, manganese, titanium, tungsten, neodymium or a combination thereof.

The present development also includes a process for preparing a catalyst having a ceria support for use in the water-gas-shift reaction. The process involves providing “clean” precursors as starting materials in the catalyst preparation.

### DESCRIPTION OF THE FIGURES

FIG. 1 is a graphical depiction of carbon monoxide conversion versus reaction temperature for a series of catalysts prepared as described herein, wherein the catalysts comprise a total platinum metal and rhenium metal concentration of about 4 wt % and the relative concentrations of platinum and rhenium are varied;

FIG. 1A is a graphical depiction of carbon monoxide conversion and methane formation versus reaction temperature for a 3 wt % Pt/1 wt % Re catalyst and for a 3 wt % Pt/0 wt % Re catalyst;

FIG. 2 is a graphical depiction of carbon monoxide conversion and methane formation versus reaction temperature for a series of catalysts prepared as described herein, wherein the catalysts comprise platinum metal concentrations of from about 0.5 wt % to about 9 wt % and the platinum to rhenium ratio is held at about 3:1;

FIG. 3 is a graphical depiction of carbon monoxide conversion versus reaction temperature for a series of catalysts prepared as described herein, wherein the platinum to rhenium ratio is varied; and

FIG. 4 is a graphical depiction of carbon monoxide conversion versus reaction temperature for a series of catalysts prepared as described herein, wherein the catalysts include platinum at about 3 wt % and essentially no rhenium and the support is varied, and the catalyst is calcined at about 500° C. for about 1 hour or for about 15 hours.

### DETAILED DESCRIPTION OF THE PRESENT DEVELOPMENT

The catalyst of the present invention is intended for use as a water-gas-shift (WGS) catalyst in a reaction suitable for conversion of hydrogen for chemical processing. The catalyst comprises a primary transition metal selected from the group consisting of iron, cobalt nickel, copper, ruthenium, rhodium, palladium, silver, osmium, iridium, platinum, gold, cadmium and a combination thereof; a transition metal promoter selected from the group consisting of rhenium, niobium, silver, manganese, vanadium, molybdenum, titanium, tungsten and a combination thereof; and a ceria-based support further comprising gadolinium, samarium, zirconium, lithium, cesium, lanthanum, praseodymium, manganese, titanium, tungsten, neodymium or a combination thereof. In an exemplary embodiment, the catalyst consists essentially of a primary transition metal selected from the group consisting of iron, cobalt, nickel, copper, ruthenium, rhodium, palladium, silver, osmium, iridium, platinum, gold, cadmium and a combination thereof, a transition metal promoter selected from the group consisting of rhenium, niobium, silver, manganese, vanadium, molybdenum, titanium, tungsten and a combination thereof; and a ceria-based support further comprising an additive selected from the group consisting of gadolinium, samarium, zirconium, lithium, cesium, lanthanum, praseodymium, manganese, titanium, tungsten, neodymium or a combination thereof. In a most preferred embodiment, the catalyst consists essentially of a platinum primary transition metal and a rhenium transition metal promoter on a ceria/zirconia support.

The primary transition metal is preferably present at a concentration (referred to herein as [Primary TM]) of from about 0.5 wt % up to about 20 wt %. The transition metal promoter is preferably present in the catalyst at a concentration (referred to herein as [Primary TM]) such that the concentration of primary transition metal to the concentration of the promoter ([Primary TM]:[Promoter]) is greater than 1:1, i.e. the promoter concentration must be greater than zero but less than the primary transition metal concentration. The cerium oxide support is present in the catalyst at a concentration of greater than about 10 wt %, wherein the additive is added to the support at a concentration of from about 0.1 wt % up to about 90 wt %.

Throughout the specification a short-hand notation is used when referring to the support. Specifically, the short-hand notation can be generalized as M1ₐM2_{b}Oₓ, wherein M1 is a first metal component, M2 is a second metal component, O is oxygen; the subscripts “a” and “b” indicate the weight percent of the components M1 and M2 relative to each other within the support; and “x” is a value appropriate to balance the charge of the support. As used herein, “surface area” refers to a BET surface area or the surface area of a particle as determined by using the Brunauer, Emmett, Teller equation for multi-molecular adsorption. The term “weight percent (wt %)” as used herein refers to the relative weight each of the above specified components contributes to the combined total weight of those components.

As is known in the art, catalysts may be loaded onto a variety of substrates depending on the intended application. The present catalyst may similarly be delivered on a variety of substrates, such as monoliths, foams, spheres, or other forms as are known in the art. When delivered in these forms and for the purposes of illustration herein, unless otherwise noted, any weight added by the substrate is not included in the wt % calculations.

The present invention can be illustrated and explained through a series of examples presented herein, which are not to be taken as limiting the present invention in any regard. Examples 1 and 2 describe general catalyst preparation procedures for preparing water-gas-shift catalysts. For the purpose of the illustration, the comparative catalyst of Example 1 includes 3 wt % platinum on a cerium oxide support, with the platinum precursor being chloroplatinic acid. An alternative method for producing a 3 wt % platinum on a cerium oxide support is provided in Example 1A. For the purpose of the illustration, the inventive catalyst of example 2 includes 3 wt % platinum and 1 wt % rhenium on a cerium zirconium oxide support, with the platinum precursor being chloroplatinic acid and the rhenium precursor being ammonium perrhenate. Examples 3-91 follow either the general preparation procedure described in Example 1 or in Example 2, with the particular general procedure and any variations noted for the specific example(s).

### EXAMPLE 1

A 100 g sample of a water-gas-shift catalyst having about 3 wt % platinum on a cerium oxide (CeO₂) support is prepared by the following steps: Samples of a cerium oxide support (CeO₂) having a surface area of greater than about 50 m² g are evaluated to determine loss of ignition, x, and to establish the wetting factor, y. Approximately (100+x)g of cerium oxide is then placed in an evaporation dish and a sufficient amount of chloroplatinic acid is added to the CeO₂ to deliver approximately 3% by weight platinum metal (starting with a 100 g CeO₂ sample, about 3.039 g Pt must be added). For easier handling and better distribution of the platinum, the chloroplatinic acid is diluted with y g of deionized water (or other appropriate solvent) before being added to the CeO₂. The platinum/CeO₂ combination is stirred occasionally while drying over a steam bath to form an impregnated powder. The impregnated powder is dried in an oven set at about 100° C. for from about 4 hours to about 24 hours, and the powder is then calcined in a furnace set at from about 440° C. to about 500° C. for from about 3 hours to about 24 hours with a heating rate of about 10° C. per minute in air. The powder is then cooled by decreasing the furnace temperature at a rate of about 60° C. per minute and the powder is returned to an evaporation dish. Approximately 100 g of a catalyst having a cerium oxide support with about 3 wt % platinum metal impregnated on the support surface, a calcined Pt/CeO₂ powder, is produced.

### EXAMPLE 1A

A 100 g sample of a water-gas-shift catalyst having about 3 wt % platinum on a cerium oxide (CeO₂) support is prepared by obtaining a CeO₂ support and determining loss of ignition, wetting factor, and the amount of chloroplatinic acid sufficient to deliver approximately 3 wt % platinum metal. An aqueous solution of chloroplatinic acid and CeO₂ powder are mixed together in a flask with a magnetic stir bar. The slurry is stirred vigorously. After about one hour, 1M NH₄OH solution is added until the pH of the entire slurry is between 7.5 and 8.5. The slurry is allowed to stir for about 24 hours and is then filtered over Waltham #1 filter paper. The filtrate is dried at about 100° C. for about 24 hours and the resulting powder is calcined at about 500° C. for from about 2 hours to about 24 hours.

### EXAMPLE 2

Samples of water-gas-shift catalysts are prepared according to the general procedure of Example 1 except the cerium oxide support (CeO₂) is replaced with a cerium zirconium oxide (CZO) support having a stoichiometry of approximately 3 cerium:1 zirconium (Ce_{0.75}Zr_{0.25}O₂) and having a surface area of greater than about 50 m²/g, so that a calcined Pt/CZO powder is produced. The calcined Pt/CZO powder is then subjected to a second impregnation process using ammonium perrhenate. For the second impregnation, a sufficient amount of ammonium perrhenate to deliver about 1 wt % rhenium metal (starting with a 100 g CZO sample, about 1.01 g Re must be added, which is about 1.45 g NH₄ReO₄ crystals) is dissolved in a sufficient quantity of deionized water to make y grams of solution. The rhenium solution is added to the calcined Pt/CZO powder, stirred over a steam bath until dry, further dried in an oven set at about 100° C. for from about 4 hours to about 24 hours, and the powder is then calcined in a furnace set at from about 440° C. to about 500° C. for from about 1 hours to about 3 hours with a heating rate of about 10° C. per minute in air. The powder is then cooled by decreasing the furnace temperature at a rate of about 60° C. per minute. Approximately 100 g of a catalyst having a cerium zirconium oxide support with about 3 wt % platinum metal and about 1 wt % rhenium metal impregnated on the support surface is produced.

### EXAMPLE 2A

Samples of water-gas-shift catalysts are prepared according to the general procedure of Example 2 except that chloroplatinic acid is replaced by platinum tetra-amine hydroxide. The amount of platinum tetra-amine hydroxide may be altered to deliver the desired platinum concentration.

The Primary Transition Metal

In the present development, platinum functions well as a primary transition metal for the catalyst because of its efficiency in carbon monoxide elimination and in hydrocarbon oxidation. However, other metals or combinations of metals, and particularly the Group VIII and Group IB transition metals, such as iron, cobalt, nickel, copper, ruthenium, rhodium, palladium, silver, osmium, iridium gold, and cadmium and rhenium may be substituted for or may be added to the platinum as appropriate to alter the equilibrium product mix.

### EXAMPLES 3-19

Samples of water-gas-shift catalysts are prepared according to the general procedure of Example 1 but the chloroplatinic acid is replaced by a series of different metal precursors, as indicated in Table I, so as to deliver the specified transition metal on the support surface.

TABLE I

| | Transition metal and | | Transition metal | | Transition metal and | | Transition metal |
|---|---|---|---|---|---|---|---|
| Ex. | concentration | | precursor | Ex. | concentration | | precursor |
| 1 | platinum | 3 wt % | H₂PtCl₆•H₂O | 11 | silver | 5 wt % | AgNO₃ |
| 3 | iron | 3 wt % | Fe(NO₃)₃•9H₂O | 12 | osmium | 3 wt % | OsO₄ solution |
| 4 | cobalt | 5 wt % | Co(NO₃)₂6H₂O | 13 | iridium | 2 wt % | H₂IrCl₆ |
| 5 | nickel | 3 wt % | Ni(NO₃)₂•6H₂O | 14 | platinum | 1 wt % | H₂PtCl₆•6H₂O |
| 6 | copper | 3 wt % | Cu(NO₃)₂•xH₂O | 15 | platinum | 1 wt % | (NH₃)₄Pt(OH)₂ |
| 7 | ruthenium | 3 wt % | Ru(NO)(NO₃)ₓ(OH)_{y}^{a} | 16 | platinum | 3 wt % | (NH₃)₄Pt(OH)₂ |
| 8 | rhodium | 2 wt % | Rh(NO₃)₃ | 17 | gold | 5 wt % | [H₃O]⁺[AuCl₄]⁻•3H₂O |
| 9 | palladium | 2 wt % | (NH₃)₄Pd(OH)₂ | 18 | rhenium | 4 wt % | NH₄ReO₄ |
| 10 | palladium | 2 wt % | (NH₃)₄Pd(NO₂)₂ | 19 | cadmium | 2 wt % | Cd(NO₃)₃•4H₂O |

wherein x + y = 3

The primary transition metal—as a single metal or as a combination of metals—is present in the catalyst composition at a predetermined concentration (“[Primary TM]”) of from about 0.5 wt % up to about 20 wt %, including the weight of the primary transition metal. Generally, the concentration of the primary transition metal will be about 5 wt % or lower due to cost considerations. The concentration selected is dependent on the anticipated reaction conditions and the desired product mixture, and may be optimized using known experimental procedures, such as performance versus concentration studies, as are known in the art.

The Transition Metal Promoter

It is known in the art that promoters may be added to a catalyst formulation to improve selected properties of the catalyst or to modify the catalyst activity and/or selectivity. Because fuel cell reformer beds must have a high level of activity under high space velocity operation, judicial selection of the promoter can produce a highly efficient catalyst at a relatively low cost. In the present invention, the primary transition metal and the transition metal promoters—individually or in combination—may be selected as desired and as appropriate to alter the equilibrium product mix. Preferably, the transition metal promoter is selected from the group consisting of lithium, potassium, rubidium, cesium, titanium, vanadium, niobium, molybdenum, tungsten, manganese, rhenium, ruthenium, rhodium, iridium, silver, neodymium, the Group VIII metals, the Group IB metals and a combination thereof.

When platinum is selected as the primary transition metal, rhenium is a particularly effective promoter for the conversion of carbon monoxide. However, other transition metal promoters may be substituted for or may be added to the rhenium as warranted by the reaction conditions. Further, when a primary transition metal other than platinum is selected, the optimum promoter may be rhenium, or rhenium used in combination with another transition metal promoter, or one or more of the other transition metal promoters as appropriate for the specific application. In an exemplary embodiment, the rhenium is present at a concentration not less than 0.6 wt %.

The transition metal promoter is present in the water-gas-shift catalyst of the present invention at a concentration such that the concentration of primary transition metal to the concentration of the promoter ([Primary TM]:[Promoter]) is greater than 1:1, i.e. the promoter concentration must be less than the primary transition metal concentration. The concentration used is dependent on the transition metal promoter selected, the primary transition metal used, the concentration of the primary transition metal, and upon the anticipated reaction conditions.

### EXAMPLES 20-35

Platinum impregnated water-gas-shift catalysts are prepared according to the general procedure of Example 1. A promoter is then added to the platinum impregnated catalyst following the procedure generally outlined in Example 2 except that the ammonium perrhenate is replaced by the designated promoter precursor, as indicated in Table II, to deliver the desired promoter to the catalyst surface.

TABLE II

| | Primary transition | | | | |
|---|---|---|---|---|---|
| Example | metal, concentration | | Promoter, concentration | | Promoter precursor |
| 20 | platinum | 1 wt % | lithium | 10 wt % | Li₂CO₃ |
| 21 | platinum | 1 wt % | potassium | 20 wt % | K₂CO₃ |
| 22 | platinum | 3 wt % | rubidium | 2 wt % | Ru₂CO₃ |
| 23 | platinum | 5 wt % | cesium | 1 wt % | Cs₂CO₃ |
| 24 | platinum | 3 wt % | titanium | 2 wt % | Ti[OCH(CH₃)₂]₄ |
| 25 | platinum | 3 wt % | vanadium | 2 wt % | VO(SO₄•xH₂O |
| 26 | platinum | 3 wt % | niobium | 2 wt % | NbCl₅ |
| 27 | platinum | 3 wt % | molybdenum | 3 wt % | Mocl₅ |
| 28 | platinum | 3 wt % | tungsten | 2 wt % | WCl₆ |
| 29 | platinum | 3 wt % | manganese | 2 wt % | MnNO₃ |
| 30 | platinum | 1 wt % | rhenium | 3 wt % | NH₄ReO₄ |
| 31 | platinum | 3 wt % | rhenium | 1 wt % | NH₄ReO₄ |
| 32 | platinum | 1 wt % | ruthenium | 0.3 wt % | Ru(NO)(NO₃)ₓOH)_{y}^{a} |
| 33 | platinum | 1.6 wt % | rhodium | 0.4 wt % | Rh(NO₃)₃ |
| 34 | platinum | 3 wt % | iridium | 2 wt % | H₂IrCl₆ |
| 35 | platinum | 3 wt % | silver | 2 wt % | AgNO₃ |

wherein x + y = 3

Because the promoter is used in combination with the primary transition metal, the concentration of the promoter may be evaluated in terms of its weight percent contribution to the catalyst or in relative terms as compared to the primary transition metal. For example, for a water-gas-shift catalyst including a primary transition metal of 3 wt % platinum and a promoter of 1 wt % rhenium, the efficiency of the catalyst for carbon monoxide conversion over the temperature range of from about 200° C. to about 400° C. may be affected by the catalyst having a total metal concentration of about 4 wt % and/or by the catalyst including 1 wt % rhenium in the composition and/or by the catalyst having a platinum metal to rhenium metal ratio of about 3:1.

### EXAMPLE 36-41

([Pt]+[Re] held at about 4 wt %; addition of Re) A series of water-gas-shift catalysts are prepared according to the general procedure of Example 2 except that a zirconium oxide (ZrO₂) support is substituted for the cerium zirconium oxide support, and the amount of platinum and rhenium are varied relative to each other while the total non-support metal concentration is held at about 4 wt % (except for Example 41 which has a metal concentration of about 3 wt %). Examples 40 and 41 followed the general procedure of Example 1.

TABLE III

| Example | Pt concentration | Re concentration | [Pt]/[Re] |
|---|---|---|---|
| 36 | 0 wt % | 4 wt % | 0 |
| 37 | 1 wt % | 3 wt % | 0.3 |
| 38 | 2 wt % | 2 wt % | 1 |
| 39 | 3 wt % | 1 wt % | 3 |
| 40 | 4 wt % | 0 wt % | — |
| 41 | 3 wt % | 0 wt % | — |

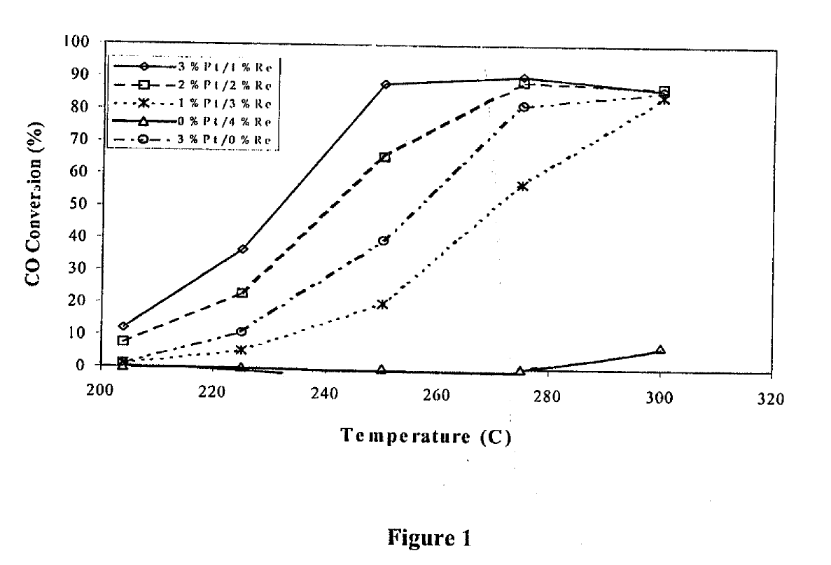

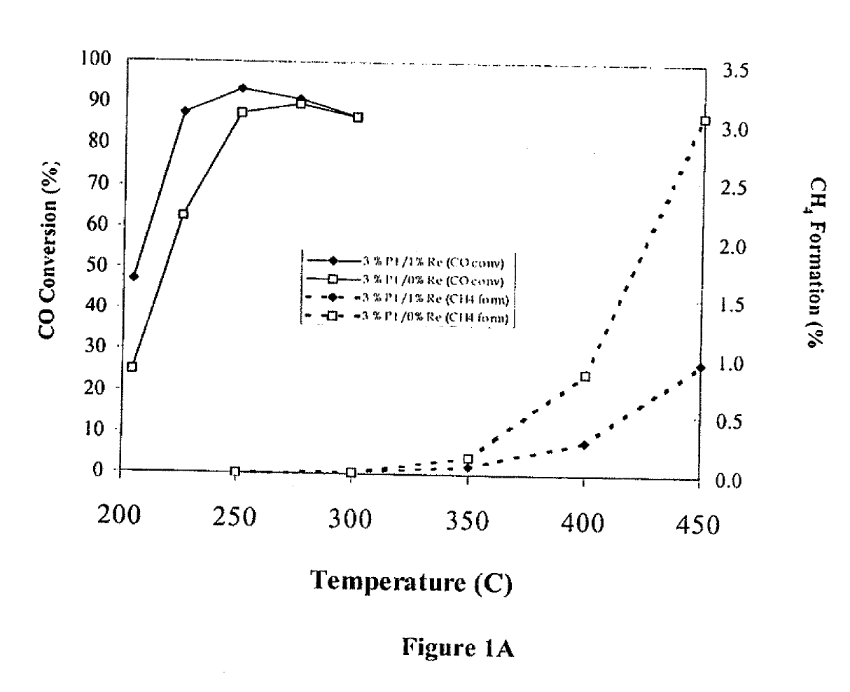

As shown in FIG. 1, when the metal concentration is held constant at about 4 wt %, the higher the platinum concentration relative to the rhenium concentration, the greater the conversion of carbon monoxide at the relatively low temperatures. As shown in FIG. 1, the 3 wt % platinum catalyst is more efficient with respect to carbon monoxide conversion when it is promoted with rhenium (Example 39, 3 wt % Pt/1 wt % Re) than when rhenium is absent (Example 41, 3 wt % Pt/0 wt % Re).

An undesirable byproduct of the water-gas-shift reaction is methane. Thus, while it is desirable to increase the rate of carbon monoxide conversion, it is also desirable to minimize the rate of methane formation. As shown in FIG. 1A, some methane is produced starting at about 350° C. using the 3 wt % Pt/1 wt % Re catalyst. However, as shown by comparing the activity of the 3 wt % Pt/0 wt % Re catalyst to the 3 wt % Pt/1 wt % Re catalyst, when rhenium is used in combination with the platinum in the water-gas-shift catalyst, the amount of methane formed is significantly reduced.

### EXAMPLE 42-50

([Pt]:[Re] held at about 3:1): Samples of water-gas-shift catalysts are prepared according to the general procedure of Example 2 except that chloroplatinic acid is replaced by platinum tetra-amine hydroxide and, as shown in Table IV, the amount of platinum tetra-amine hydroxide and the amount of ammonium perrhenate added to the composition are varied while maintaining a platinum to rhenium ratio of about 3:1.

TABLE IV

| Example | Pt concentration | Re concentration |
|---|---|---|
| 42 | 0.5 wt % | 0.167 wt % |
| 43 | 1.0 wt % | 0.33 wt % |
| 44 | 2.0 wt % | 0.67 wt % |
| 45 | 3 wt % | 1 wt % |
| 46 | 6 wt % | 2 wt % |
| 47 | 9 wt % | 3 wt % |
| 48 | 12 wt % | 4 wt % |
| 49 | 15 wt % | 5 wt % |
| 50 | 21 wt % | 7 wt % |

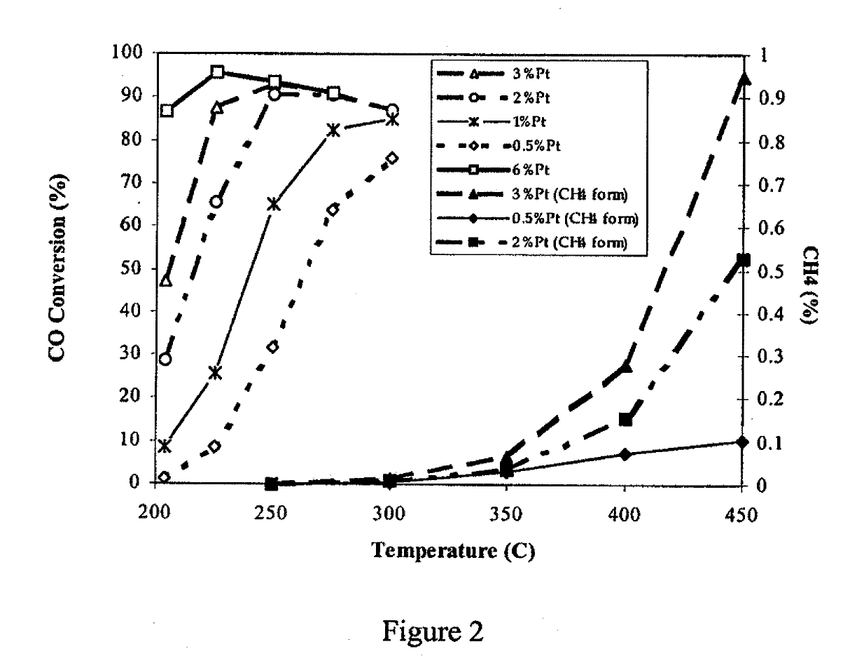

FIG. 2 shows the carbon monoxide conversion activity and the methane formation over the temperature range of from about 200° C. to about 450° C. for the catalysts prepared according to Examples 42-46. When the [Pt]:[Re] is held at about 3:1, the carbon monoxide conversion increases as the metal concentrations increase over the reaction temperature range of from about 200° C. to about 300° C. The benefits of the higher metal concentrations are particularly evident in the temperature range of from about 205° C. to about 225° C.

Further, as shown in FIG. 2, some methane is produced starting at about 350° C. using the platinum/rhenium catalysts having a [Pt]:[Re] of about 3:1. However, the overall methane formation remains extremely low even at a platinum concentration of about 3 wt %.

### EXAMPLES 51-61

([Pt]:[Re] varied from about 1:1 to about 9:1) A series of water-gas-shift catalysts are prepared according to the general procedure of Example 2 except that the chloroplatinic acid is replaced by platinum tetra-amine hydroxide, and the amount of platinum tetra-amine hydroxide and the ammonium perrhenate are varied as necessary to deliver the platinum metal and rhenium metal concentrations as shown in Table V. Examples 51 and 52 are prepared according to the general procedure of Example 1 with platinum tetra-amine hydroxide replacing the chloroplatinic acid and the cerium zirconium oxide replacing the CeO₂ support.

TABLE V

| Example | Pt concentration | Re concentration | [Pt]:[Re] |
|---|---|---|---|
| 51 | 3 wt % | 0 wt % | — |
| 52 | 3 wt % | 0 wt % | — |
| 53 | 3 wt % | 3 wt % | 1:1 |
| 54 | 3 wt % | 2 wt % | 1.5:1 |
| 55 | 3 wt % | 1.5 wt % | 2:1 |
| 56 | 3 wt % | 1 wt % | 3:1 |
| 57 | 3.2 wt % | 0.8 wt % | 4:1 |
| 58 | 6 wt % | 1 wt % | 6:1 |
| 59 | 3 wt % | 0.43 wt % | 7:1 |
| 60 | 3.5 wt % | 0.5 wt % | 7:1 |
| 61 | 9 wt % | 1 wt % | 9:1 |

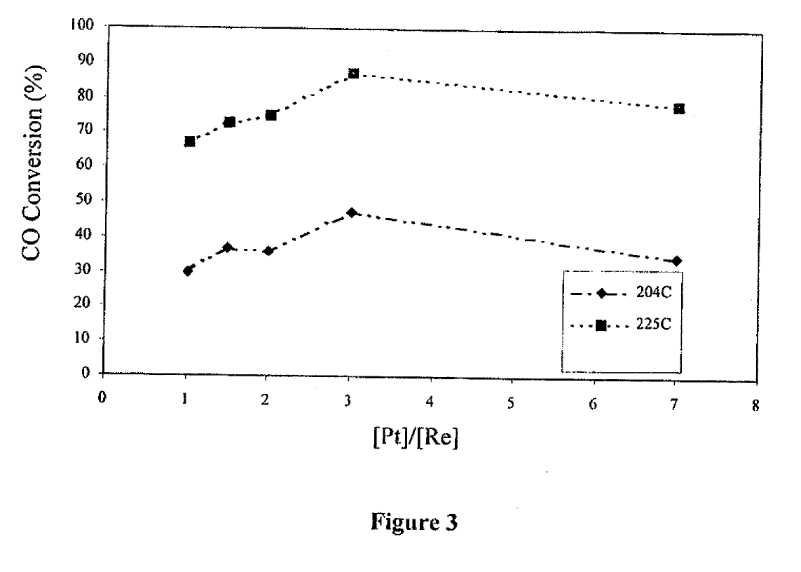

FIG. 3 shows the carbon monoxide conversion at two typical reaction temperatures (204° C., 225° C.,) for catalyst having about 3 wt % platinum and having [Pt]:[Re] varying from about 1:1 to about 7:1. As shown in FIG. 3, the carbon monoxide conversion increases as the platinum to rhenium ratio increases from about 1:1 to about 3:1. The enhanced performance for the 3:1 [Pt]:[Re] catalyst as compared to the 7:1 catalyst may be due to a number of factors, such as, the absolute rhenium concentration may be insufficient—being below 0.6 wt %—to function as an optimum promoter.

The Support

The water-gas-shift catalyst support of the present invention comprises a ceria-based material that is present at a concentration of greater than about 10 wt %. To enhance the CeO₂ performance, additives such as gadolinium, samarium, zirconium, lithium, cesium, lanthanum, praseodymium, manganese, titanium, tungsten or a combination thereof may be used in the ceria-based support, such as shown in Table VI. The additive is generally present at a concentration of from about 0 wt % to about 90 wt %. Although the ceria-based supports are preferred for the present invention, non-cerium inclusive supports known in the art can also be used to deliver the Group VIII or Group IB metal and the transition metal promoter.

### EXAMPLE 62-69

Samples of water-gas-shift catalysts are made according to the general procedure of Example 2 except that the cerium oxide support is substituted with the support material listed in Table VI for the particular example.

TABLE VI

| Example | Support | Example | Support |
|---|---|---|---|
| 62 | Ce_{0.7}Gd_{0.2}Zr_{0.1}Oₓ | 66 | CeO₂/Al₂O₃ |
| 63 | Ce_{0.7}Sm_{0.2}Zr_{0.1}Oₓ | 67 | 20% ZrO₂/80% TiO₂ |
| 64 | Ce_{0.6}Mn_{0.4}O₂ | 68 | 50% ZrO₂/50% TiO₂ |
| 65 | cerium metal | 69 | 80% ZrO₂/20% TiO₂ |

Mixed cerium zirconium oxide is a preferred support for the platinum/rhenium containing catalyst. The cerium to zirconium ratio can be varied as necessary to optimize the catalyst performance. In the present development using a platinum primary metal and a rhenium promoter, it has been found that a cerium zirconium oxide support which is rich in zirconium, i.e. in which the weight percent added to the support by the zirconium is greater than the weight percent added to the support by the cerium, demonstrates a surprisingly improved level of CO conversion without concomitant significant methane formation. For example, for the catalyst comprising about 3 wt % platinum and about 1 wt % rhenium, a preferred support is Ce_{0.25}Zr_{0.75}O₂ having a surface area greater than about 10 m²/g, and preferably having a surface area of from about 50 m²/g to about 200 m²/g. Alternatively, a cerium zirconium oxide support which is rich in cerium, such as Ce_{0.8}Zr_{0.2}O₂ having a surface area greater than about 30 m²/g, and preferably having a surface area of from about 50 m²/g to about 150 m²/g, has also shown acceptable levels of CO conversion without concomitant significant methane formation. Further it is preferred that the support be essentially absent of known catalytic poisons, such as sulfur, which are known in the art.

### EXAMPLES 70-76

Samples of water-gas-shift catalysts are prepared according to the general procedure of Example 1 except that the cerium oxide support is substituted with the support material noted in Table VII for the particular example.

### EXAMPLE 77-85

Samples of water-gas-shift catalysts are prepared according to the general procedure of Example 2 except that the cerium zirconium oxide support is substituted with the support material noted in Table VII for the particular example.

TABLE VII

| Example | Pt concentration | Re concentration | Support |
|---|---|---|---|
| 70 | 3 wt % | 0 wt % | CeO₂ |
| 71 | 3 wt % | 0 wt % | Ce_{0.8}Zr_{0.2}O₂ |
| 72 | 3 wt % | 0 wt % | Ce_{0.75}Zr_{0.25}O₂ |
| 73 | 3 wt % | 0 wt % | Ce_{0.7}Zr_{0.3}O₂ |
| 74 | 3 wt % | 0 wt % | Ce_{0.5}Zr_{0.5}O₂ |
| 74 | 3 wt % | 0 wt % | ZrO₂ |
| 76 | 6 wt % | 0 wt % | Ce_{0.75}Zr_{0.25}O₂ |
| 77 | 3 wt % | 1 wt % | CeO₂ |
| 78 | 3 wt % | 1 wt % | Ce_{0.9}Zr_{0.1}O₂ |
| 79 | 3 wt % | 1 wt % | Ce_{0.8}Zr_{0.2}O₂ |
| 80 | 3 wt % | 1 wt % | Ce_{0.75}Zr_{0.25}O₂ |
| 81 | 3 wt % | 1 wt % | Ce_{0.7}Zr_{0.3}O₂ |
| 82 | 3 wt % | 1 wt % | Ce_{0.5}Zr_{0.5}O₂ |
| 2 | 3 wt % | 1 wt % | Ce_{0.25}Zr_{0.75}O₂ |
| 83 | 3 wt % | 1 wt % | Ce_{0.2}Zr_{0.8}O₂ |
| 84 | 3 wt % | 1 wt % | ZrO₂ |
| 85 | 6 wt % | 1 wt % | Ce_{0.75}Zr_{0.25}O₂ |

Precursor Ligands and Catalyst Preparation

The preparation method can affect the performance of the water-gas-shift catalyst. For example, as is known the art, the primary transition metal(s) and the transition metal promoter(s) are generally provided in the form of a metal-based precursor for impregnation on a support material. The metal-based precursor generally includes one or more substituents or ligands which separate from the metal when the metal is impregnated on the support material. Although the ligands of the precursor are not believed to be materials of the finished catalyst, they may affect how the support receives the transition metal and/or the promoter. Further, as is known in the art, certain ligands or substituents may negatively affect the support surface and may effectively “poison” the catalyst.

In the present development, the primary transition metal and the promoter are preferably based on clean precursors, wherein the term “clean” refers to a precursor which does not include one or more potentially catalytically poisonous substituents or to a precursor from which the potentially catalytically poisonous substituents can be removed with relative ease during the catalyst preparation process. As is known in the art, a potentially poisonous substituent is any element which can adsorb to the support surface in such a manner so as to prevent one or more sites on the support surface from participating in the desired catalytic reaction. For water-gas-shift catalysts, some commonly recognized poisons are sulfur, chlorine, sodium, bromine, iodine or combinations thereof. Depending on the particular support material selected, other substituents may be included in the list of potential poisons based on their reactivity.

In the present development some representative “clean” precursors would include complexes having ligands selected from the group consisting of ammonia, primary amines, secondary amines, tertiary amines, quaternary amines, nitrates, nitrites, hydroxyl groups, carbonyls, carbonates, aqua ions, oxides, oxylates, and combinations thereof. For example, for the platinum containing catalysts, the platinum may be delivered to the support in the form of a platinum tetra-amine hydroxide solution, a platinum tetra-amine nitrate, a platinum di-amine nitrate, platinum oxalate, platinum nitrate or other similar platinum-based complexes. When the platinum is delivered to the support in the form of the platinum tetra-amine hydroxide solution the resultant water-gas-shift catalyst has a slightly greater carbon monoxide conversion profile than when other precursor materials are used. Similarly, the rhenium may be provided as a clean precursor in the form of ammonium perrhenate or as one of the known rhenium oxide complexes, such as ReO₂, ReO₃ or Re₂O₇.

Alternatively, the primary transition metal precursor and the promoter precursor may include substituents which may potentially be poisonous to the catalyst, but which can be removed with relative ease during the catalyst production process to a sufficient extent so as to make the catalyst “clean.” For example, as indicated in Example 1 or Example 1A and several related examples herein, chloroplatinic acid may be used as a platinum source with the chlorine being removed by air calcination. Depending on the concentration of chlorine present in the catalyst following calcination, the catalyst may be washed by various methods known in the art such as water washing, washing with basic solution, steam calcination, reducing the catalyst with hydrogen and/or other reducing agents followed by washing.

As is known in the art, catalysts are frequently calcined to drive off volatile matter or to effect changes in the catalyst. The calcination time and temperature can affect the catalyst performance, and it is recommended that the calcination conditions be optimized for the particular desired catalyst composition and intended use. In the present invention, the catalyst is calcined after the primary transition metal is added to the support. When the primary transition metal is platinum which is delivered to the catalyst in the form of chloroplatinic acid, and the support comprises ceria, the catalyst is calcined in a furnace set at from about 440° C. to about 500° C. for up to about 20 hours, preferably from about 1 hour to about 17 hours, and more preferably from about 12 hours to about 16 hours, with a heating rate of about 10° C. per minute in air. If a transition metal promoter is added to the primary transition metal catalyst, the catalyst is calcined after the addition of the promoter in a furnace set at from about 440° C. to about 500° C. for up to about 4 hours, preferably from about 1 hour to about 3 hours, with a heating rate of about 10° C. per minute in air.

### EXAMPLES 86-91

Samples of water-gas-shift catalysts are prepared according to the general procedure of Example 1 and are calcined at about 500° C. for either about 1 hour or for about 15 hours as noted in Table VIII. Examples 88-89 vary from Example 1 by substituting a zirconium oxide support for the cerium oxide support. Examples 90-91 vary from Example 1 by substituting a cerium zirconium oxide support for the cerium oxide support.

TABLE VIII

| | | | | Calcination | |
|---|---|---|---|---|---|
| | | | | Time, | Residual |
| Example | Pt conc. | Re conc. | Support | Temp | Chlorine |
| 86 | 3 wt % | 0 wt % | CeO₂ | 500° C., | 2.0% |
| | | | | 1 hour | |
| 87 | 3 wt % | 0 wt % | CeO₂ | 500° C., | 0.6% |
| | | | | 15 hours | |
| 88 | 3 wt % | 0 wt % | ZrO₂ | 500° C., | 0.8% |
| | | | | 1 hour | |
| 89 | 3 wt % | 0 wt % | ZrO₂ | 500° C., | 0.2% |
| | | | | 15 hours | |
| 90 | 3 wt % | 0 wt % | Ce_{0.8}Zr_{0.2}O₂ | 500° C., | 1.6% |
| | | | | 1 hour | |
| 91 | 3 wt % | 0 wt % | Ce_{0.8}Zr_{0.2}O₂ | 500° C., | 0.6% |
| | | | | 15 hours | |

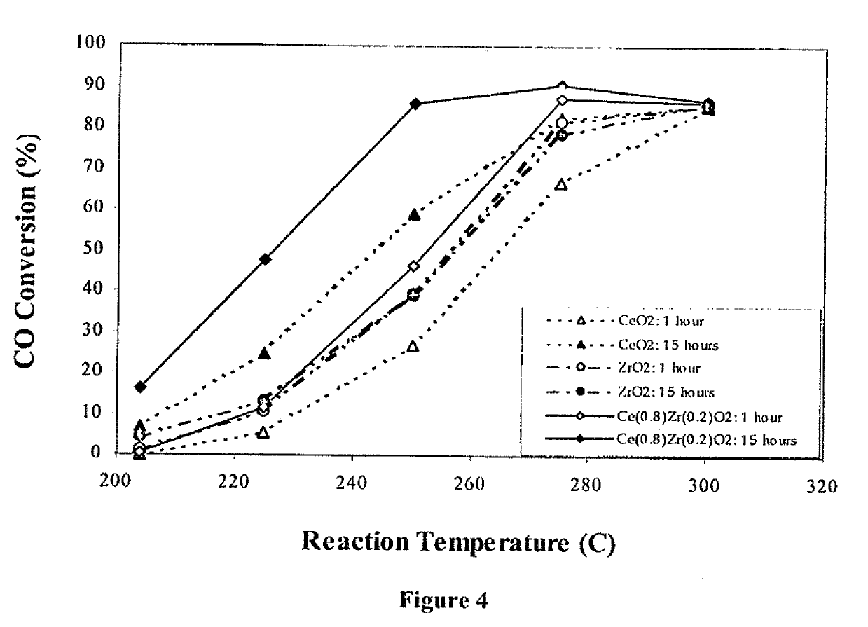

As shown in FIG. 4, for catalysts having about 3 wt % platinum and having a cerium oxide support, the carbon monoxide conversion is improved by calcining the catalyst for about 15 hours as compared to calcining the catalyst for about 1 hour. In contrast essentially no improvement in CO conversion is observed for zirconium oxide supported catalysts as the calcination time is lengthened. However, when the support includes both cerium and zirconium, longer calcination times result in improved CO conversion similar to that observed for the cerium oxide supported catalysts.

The catalyst may be delivered on substrates other than monoliths, foams, spheres, or similar substrates. For example, the present catalyst may be delivered in the form of extrudates, tabs, pellets, multi-passage substrates or similarly prepared materials. When delivered in these forms, the catalytic activity is dependent on the relative amounts of the active components on the substrate surface because it is essentially only the surface components which can participate in the water-gas-shift reaction. As is known in the art, when delivered in these alternative forms, the concentration of the components is more accurately referred to in terms of the surface concentration or in grams of specific metal per liter of catalyst.

There are numerous ways in which metals can be combined with supports to produce catalyst. In the examples presented herein, the metals have been combined with the support using known impregnation techniques. However, other methods may be used, such as co-precipitation, sol-gel, vapor deposition, chemical vapor deposition, deposition precipitation, sequential precipitation, mechanical mixing, decomposition and other methods which are known in the art. Any means for combining metals with a support to produce a catalyst which has the composition described herein is believed to fall within the scope of this invention.

On-Stream Performance

Like all catalysts, the water-gas-shift catalyst itself is not permanently altered in the water-gas-shift reaction. However, over time the catalyst efficiency can be diminished by contamination of the active sites, for example, by deposition of carbon or other contaminants in the material feed, thus requiring the catalyst bed to be cleaned or regenerated. Because fuel cells, and particularly mobile fuel cells, are being considered for use in consumer vehicles, proper routine maintenance may be difficult to ensure. Thus, a desirable water-gas-shift catalyst should be able to remain on stream for an extended period between catalyst regeneration.

The primary transition metal, promoter and support affect the on-stream performance, and may be combined to optimize the on-stream performance as desired. In the present development, the platinum on a cerium zirconium oxide support performs adequately for extended periods on-stream and following regeneration. However, the addition of rhenium significantly improves the on-stream performance before, and particularly following, the regeneration cycles.

It is understood that variations may be made which would fall within the scope of this development. For example, precursor materials other than those expressly listed may be employed to deliver the desired primary transition metal(s) and/or the promoter(s), or the processing conditions may be varied without exceeding the scope of this development. Further, the active catalyst may be delivered in a form that includes essentially inert components. In the latter case, the inert components should be disregarded in any calculations when determining the relative weight percentages of the active components.

What is claimed is:

1. A catalyst suitable for production of hydrogen, said catalyst comprising:
a. a primary transition metal selected from the group consisting of iron, cobalt, nickel, copper, ruthenium, rhodium, palladium, silver, osmium, iridium, platinum, gold, cadmium and a combination thereof, said primary transition metal being present at a predetermined concentration [Primary TM] and wherein said [Primary TM] is from 0.5 wt % to 20 wt %;
b. a transition metal promoter selected from the group consisting of lithium, potassium, rubidium, cesium, titanium, vanadium, niobium, molybdenum, tungsten, manganese, rhenium, ruthenium, rhodium, iridium, silver, neodymium, the Group VIII metals, the Group IB metals and a combination thereof, said promoter being present at a predetermined concentration [Promoter] selected such that a ratio defined by [Primary TM]:[Promoter] is greater than 1:1; and
c. a support material comprising cerium oxide and an additive selected from the group consisting of gadolinium, samarium, zirconium, lithium, cesium, lanthanum, praseodymium, manganese, titanium, tungsten, neodymium and a combination thereof,
wherein said transition metal and said promoter are combined with said support material to form said catalyst.

2. The catalyst of claim 1 wherein said support material comprises cerium oxide at a concentration of greater than about 10 wt %.

3. The catalyst of claim 2 wherein said support material is a mixed cerium zirconium oxide comprising zirconium at a higher weight percent than cerium.

4. The catalyst of claim 2 wherein said support material is a mixed cerium zirconium oxide comprising cerium at a higher weight percent than zirconium.

5. The catalyst of claim 2 wherein said support material has a surface area of from about 10 m²/g to about 200 m²/g.

6. The catalyst of claim 1 wherein said catalyst is combined with a substrate, wherein said substrate is a monolith, a foam, a sphere, an extrudate, a tab, a pellet, a multi-passage substrate or a combination thereof.

7. A catalyst suitable for production of hydrogen, said catalyst comprising:
a. platinum present at a predetermined concentration [Primary TM] and wherein said [Primary TM] is less than 20 wt %;
b. rhenium present at a predetermined concentration [Promoter] selected such that a ratio defined by [Primary TM]:[Promoter] is greater than 1:1 and wherein said [Promoter] is not less than 0.6 wt %; and
c. a support material comprising cerium oxide and zirconium oxide, wherein said support material has a surface area of from about 10 m²/g to about 200 m²/g,
wherein said transition metal and said promoter are combined with said support material to form said catalyst.

8. The catalyst of claim 7 wherein said support material is a mixed cerium zirconium oxide comprising zirconium at a higher weight percent than cerium.

9. The catalyst of claim 7 wherein said support material is a mixed cerium zirconium oxide comprising cerium at a higher weight percent than zirconium.

10. A method of making a catalyst suitable for production of hydrogen, said method comprising:
a. selecting a primary transition metal from the group consisting of iron, cobalt, nickel, copper, ruthenium, rhodium, palladium, silver, osmium, iridium, platinum, gold, cadmium and a combination thereof;
b. selecting a transition metal promoter from the group consisting of lithium, potassium, rubidium, cesium, titanium, vanadium, niobium, molybdenum, tungsten, manganese, rhenium, ruthenium, rhodium, iridium, silver, neodymium, the Group VIII metals, the Group IB metals and a combination thereof;
c. selecting a support material comprising cerium oxide and an additive selected from the group consisting of gadolinium, samarium, zirconium, lithium, cesium, lanthanum, praseodymium, manganese, titanium, tungsten, neodymium and a combination thereof;
d. impregnating said transition metal onto said support material so as to deliver a predetermined concentration of transition metal [Primary TM] and wherein said [Primary TM] is from 0.5 wt % to 20 wt %;
e. calcining said transition metal impregnated support of step d;
f. impregnating said promoter onto said transition metal impregnated support so as to deliver a predetermined concentration of promoter [Promoter] and wherein a ratio defined by [Primary TM]:[Promoter] is greater than 1:1; and
g. calcining said promoter impregnated support of step f to produce said catalyst.

11. The method of claim 10 wherein said primary transition metal is delivered to said support as a solvent containing a predetermined concentration of a first transition metal precursor defined as a transition metal complex having at least one ligand and wherein said ligand is absent of sulfur, chlorine, sodium, bromine, and iodine, and wherein said promoter is delivered to said transition metal inclusive support as a solvent containing a predetermined concentration of a second transition metal precursor defined as a transition metal complex having at least one ligand and wherein said ligand is absent of sulfur, chlorine, sodium, bromine, and iodine.

12. The catalyst of claim 11 wherein said first transition metal precursor is a transition metal complex having ligands selected from the group consisting of ammonia, primary amines, secondary amines, tertiary amines, quaternary amines, nitrates, nitrites, hydroxyl groups, carbonyls, carbonates, aqua ions, oxides, oxylates, and combinations thereof.

13. The catalyst of claim 11 wherein said first transition metal precursor is selected from the group consisting of platinum tetra-amine hydroxide, platinum tetra-amine nitrate, platinum divine nitrate and a combination thereof.

14. The catalyst of claim 11 wherein said second transition metal precursor is selected from the group consisting of ammonium perrhenate, a rhenium oxide complex, ReO₂, ReO₃ or Re₂O₇.

15. The catalyst of claim 10 wherein said catalyst is combined with a substrate, wherein said substrate is a monolith, a foam, a sphere, an extrudate, a tab, a pellet, a multi-passage substrate or a combination thereof.
